(19) United States
(12) Patent Application Publication
(10) Pub. No.: US 2010/0117811 A1
(43) Pub. Date: May 13, 2010

(54) DIRECTION SIGNAL LIGHT

(76) Inventor: Linming Liu, Taipei City (TW)

Correspondence Address: LEONG C LEI, PMB # 1008, 1867 YGNACIO VALLEY ROAD, WALNUT CREEK, CA, 94598, US

(21) Appl. No.: 12/269,896

(22) Filed: Nov. 13, 2008

(51) Int. Cl. B62J 6/00

(52) U.S. Cl. 340/432

(57) ABSTRACT

A direction signal light for bicycle is disclosed. The signal light comprises a controller, a direction signal seat, a red light and amber light module, characterized in that the controller having a touch control switch for left turning and right turning light is disposed at one end position of the handle of the bicycle, signal from the touch control switch is transmitted via wire or wireless transmission device to the direction signal light seat at the bottom section of the seat pad of the bicycle; the front section of the direction signal light seat is secured to a supporting rod below the seat pad, and the rear section of the direction signal light seat is provided with a center red light, a left amber light and a right amber light, and the interior of the direction signal light seat contains a wireless signal receiving device; and the red light is mounted at the center position at the rear section of the direction signals light seat, upon the triggering of the red light, the red light remains, and the left amber and right amber light being at the side position is extendable or retractable and the light or right amber light blinks when the switch is on.

### TECHNICAL FIELD OF THE INVENTION

The present invention relates to direction signal light, and in particular, to direction signal light which is extendable with respect to its width.

### DESCRIPTION OF THE PRIOR ART

Bicycle with wireless transmission in controlling the direction signal light mounted at the end of the bicycle is not widely known but wireless transmission is very convenient in controlling signal. It is therefore conventional type of direction light structure for bicycle should be improved.

Bicycle for professional cyclists generally has a seat pad a higher position, the rear light mounted at a horizontal support below the seat pad allows people from behind to easily see the cyclists. However, for bicycles with a low seat pad, it is important to have a direction signal light structure which can be extended.

### SUMMARY OF THE INVENTION

Accordingly, it is an object of the present invention to provide a direction signal light for bicycle comprising a controller, a direction signal seat, a red light and amber light module, characterized in that the controller having a touch control switch for left turning and right turning light is disposed at one end position of the handle of the bicycle, signal from the touch control switch is transmitted via wire or wireless transmission device to the direction signal light seat at the bottom section of the seat pad of the bicycle; the front section of the direction signal light seat is secured to a supporting rod below the seat pad, and the rear section of the direction signal light seat is provided with a center red light, a left amber light and a right amber light, and the interior of the direction signal light seat contains a wireless signal receiving device; and the red light is mounted at the center position at the rear section of the direction signals light seat, upon the triggering of the red light, the red light remains, and the left amber and right amber light being at the side position is extendable or retractable and the light or right amber light blinks when the switch is on.

Other objects, and advantages will become more apparent in view of the following detailed description in conjunction with the accompanying drawings.

### BRIEF DESCRIPTION OF THE DRAWINGS

FIG. 1 shows a flowchart of a wireless transmission system of a controller of the present invention.

FIG. 2 shows a flowchart of a wireless receiving system of a direction signal light seat of the present invention.

FIGS. 3 to 5 show schematic views of the preferred embodiment of the present invention.

### DETAILED DESCRIPTION OF THE PREFERRED EMBODIMENTS

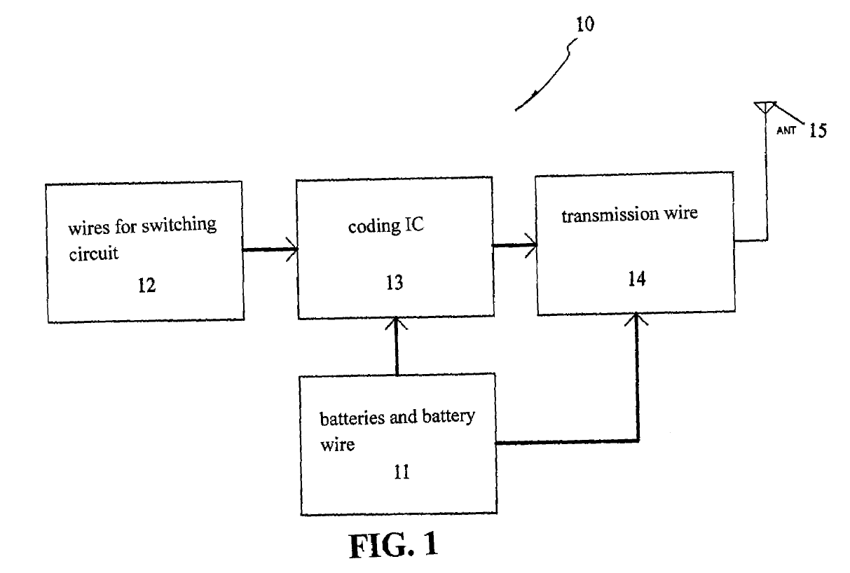

Referring to FIG. 1, there is shown a schematic flowchart of a wireless transmission system of a controller in accordance with the present invention. When a wireless transmission system 10 is switched on, batteries and battery wire 11 respectively supply electrical energy to coding IC 13 and transmission wire 14, and the wires for switching circuit 12 for the red light, left and right turning amber light is first connected to the coding IC 13 and is then connected to the transmission wire 14. Via an antenna 15, the control signal for left and right turning amber light is transmitted to the direction signal light seat as flashing amber light for left and right turning. The center red light is permanently lighted without turning off.

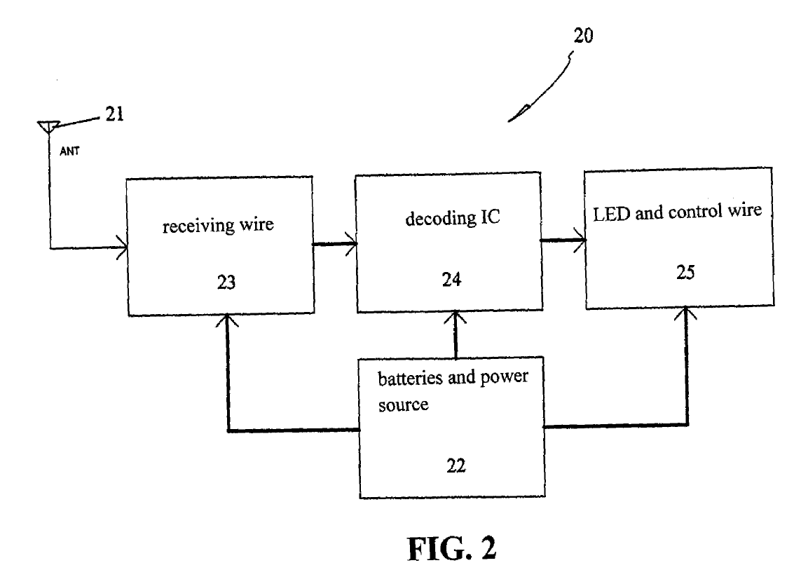

Referring to FIG. 2, there is shown a flowchart of a wireless receiving system of a direction light seat in accordance with the present invention. The wireless receiving system 20 is in combination with the wireless transmission system of the controller 10 and are in operation. Batteries and power source wire 22 respectively provide electrical energy to the receiving wire 23, the decoding IC 24, LED and the controlling wire 25, and the signal from ON and OFF signal transmitted from the controller via the antenna 21 is received, by first passing the receiving wire 23, via the decoding IC 24, then to the LED and control wire 25 as lighted.

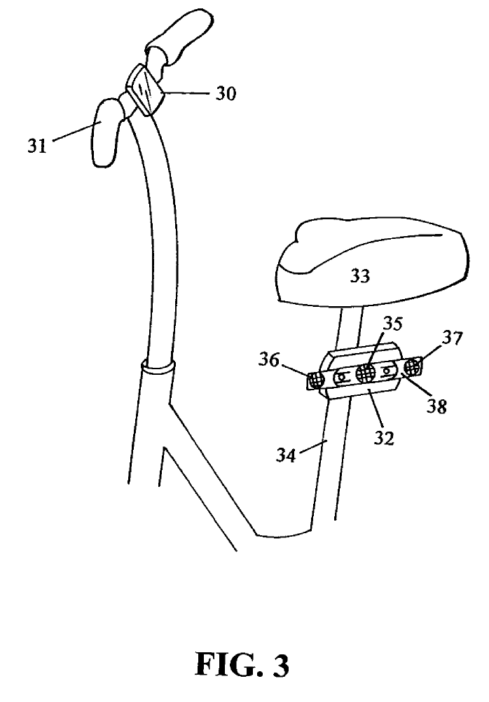

Referring to FIG. 3, there is shown a schematic view of a preferred embodiment in accordance with the present invention. The controller 30 is mounted onto the handle bar 31 of a bicycle. The rear light seat 32 is positioned at a supporting rod 34 beneath the seat pad 33. The cyclist switches on the controller 30 and the power source of the direction signal light seat 32. At this point of time the center red light 35 is lighted and remains lighted. If the cyclist wishes to turn the bicycle to left side, the left turn on the panel of the controller 30 is touched and the left turn amber light 36 flashes and at the same time, it is indicated on the panel. After the bicycle is in a straight position, the left turn signal is off. If the cyclist wishes to turn right, the left turn switch on panel of the controller 30 is touched, and the right turn light flashes and also is indicated on the panel. The wide of the signal light can be extended outward (laterally) if it is needed.

The left turn light 36 and the right turn light 37 is extendable from the housing 38.

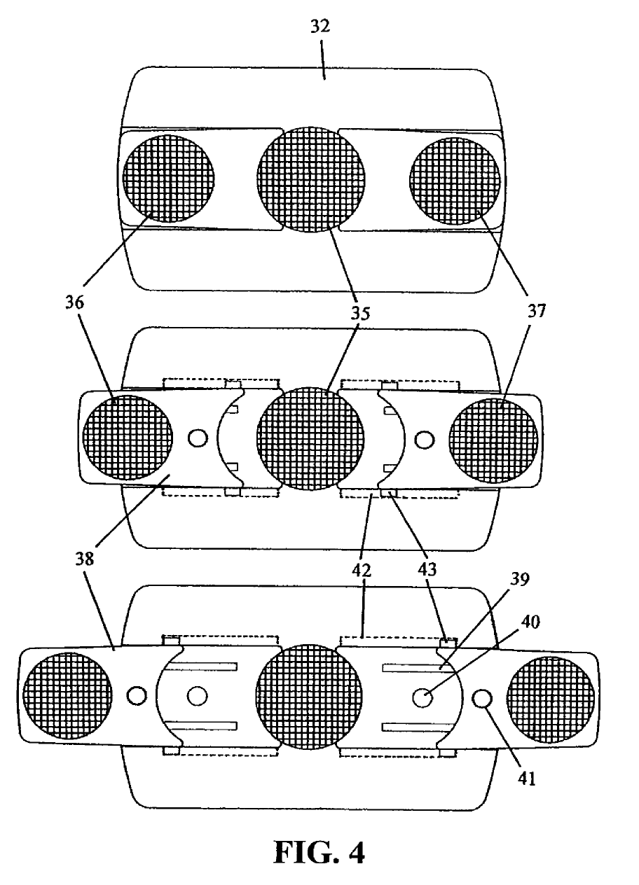

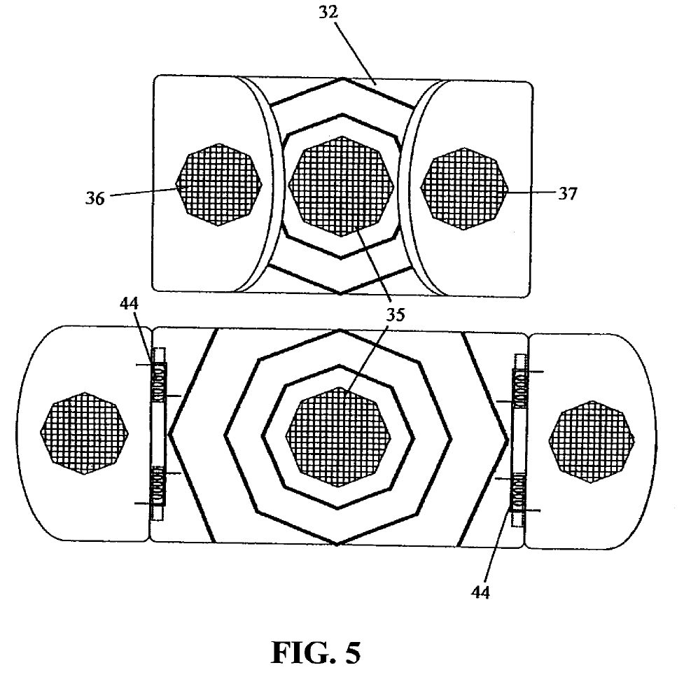

As shown in FIG. 4, the top drawing indicates the light seat 32 is yet to be extended laterally. One middle drawing indicates the left turn amber light 36 is extended and the right turn light 37 is extended halfway. The bottom drawing indicates that the extended recess 39 and protrusion 40 of the direction signal light seat 32 is in combination with the protruded edge at the inner edge of the housing 38 and the protruded point 41, and is embedded at the blocking plate 43 of the slip 42. Thus the length of the extension can be extended based on requirement

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A direction signal light for bicycle comprising a controller, a direction signal seat, a red light and amber light module, characterized in that
the controller having a touch control switch for left turning and right turning light is disposed at one end position of the handle of the bicycle, signal from the touch control switch is transmitted via wire or wireless transmission device to the direction signal light seat at the bottom section of the seat pad of the bicycle; the front section of the direction signal light seat is secured to a supporting rod below the seat pad, and the rear section of the direction signal light seat is provided with a center red light, a left amber light and a right amber light, and the interior of the direction signal light seat contains a wireless signal receiving device; and the red light is mounted at the center position at the rear section of the direction signals light seat, upon the triggering of the red light, the red light remains, and the left amber and right amber light being at the side position is extendable or retractable and the light or right amber light blinks when the switch is on.
